(19) United States
(12) Patent Application Publication
(10) Pub. No.: US 2012/0210018 A1
(43) Pub. Date: Aug. 16, 2012

(54) System And Method for Lock-Less Multi-Core IP Forwarding

(76) Inventors: Rikard MENDEL, Solna (SE); Markus Carlstedt, Uppsala (SE); Roger Keith Wiles, Corinth, TX (US)

(21) Appl. No.: 13/025,264

(22) Filed: Feb. 11, 2011

(51) Int. Cl. G06F 15/16

(52) U.S. Cl. 709/242; 709/238

(57) ABSTRACT

Described herein are systems and methods using lock-less multi-core IP forwarding having dedicated forwarding cores. The exemplary embodiments may offer wire-rate on multiple gigabit links while guaranteeing packet order. One embodiment relates to a system including a plurality of forwarding cores within a network, and a routing table, wherein a first forwarding core of the plurality of forwarding cores polls data received from an input interface for routing information, references the routing table based on the routing information, determines a destination for the data based on the routing table, and transmits the data to the destination at a wire-rate, the wire-rate is independent from a further wire-rate corresponding to a further forwarding core of the plurality of forwarding cores.

### BACKGROUND

The Internet Protocol (“IP”) is defined as the principal communications protocol used for relaying information, or data packets, across a network using the Internet Protocol Suite (“IPS”). This protocol is responsible for the routing of these packets across network boundaries, and is the primary protocol that establishes the Internet. In addition, IP is the primary protocol in the Internet Layer of the IPS and has the task of delivering data packets from the source host to the destination host solely across one or more networks based on their respective addresses. An IP address is a numerical label assigned to any computing device (e.g., computer, mobile telephone, printer, etc.) participating in a computer network that uses the IP for communication. In addition to identifying hosts, these addresses provide a logical location service.

IP addressing refers to how end hosts become assigned with IP addresses, and how sub-networks of IP host addresses are divided and grouped together. IP routing is performed by all hosts, including inter-network IP routers. These routers may utilize either interior gateway protocols (“IGPs”) or external gateway protocols (“EGPs”) in order to make IP packet-forwarding decisions across IP connected networks. In other words, routing is the process of selecting paths in a network along which to send network traffic. In a packet switching network, IP routing directs the transit, or forwards, logically addressed packets from their source toward their ultimate destination through intermediate nodes, such as hardware devices (e.g., routers, bridges, gateways, firewalls, switches, etc.).

### SUMMARY OF THE INVENTION

Described herein are systems and methods using lock-less multi-core IP forwarding having dedicated forwarding cores. The exemplary embodiments may offer wire-rate on multiple gigabit links while guaranteeing packet order. One embodiment relates to a non-transitory computer readable storage medium including a set of instructions executable by a processor, the set of instructions operable to poll, by a forwarding core, data received from an input interface for routing information, wherein the forwarding core is one of a plurality of forwarding cores, reference a routing table based on the routing information, determine a destination for the data based on the routing table, and transmit the data to the destination at a wire-rate, wherein the wire-rate is independent from a further wire-rate corresponding to a further forwarding core of the plurality of forwarding cores.

Another embodiment relates to a system including a plurality of forwarding cores within a network, and a routing table, wherein a first forwarding core of the plurality of forwarding cores polls data received from an input interface for routing information, references the routing table based on the routing information, determines a destination for the data based on the routing table, and transmitting the data to the destination at a wire-rate, the wire-rate is independent from a further wire-rate corresponding to a further forwarding core of the plurality of forwarding cores.

A further embodiment relates to A data-forwarding system including a polling means polling data received from an input interface for routing information, a look-up means referencing a routing table based on the routing information, a routing means determining a destination for the data based on the routing table, and a transmitting means transmitting the data to the destination at a wire-rate, wherein the wire-rate is independent from a further wire-rate corresponding to a further transmitting means within the system.

### BRIEF DESCRIPTION OF THE DRAWINGS

FIG. 1 shows an exemplary embodiment of a system for offering wire-rate on multiple links with guaranteed packet order according to the exemplary embodiments described herein.

FIG. 2 shows an exemplary embodiment of a method for offering wire-rate on multiple links with guaranteed packet order according to the exemplary embodiments described herein.

### DETAILED DESCRIPTION

The exemplary embodiments may be further understood with reference to the following description and the appended drawings, wherein like elements are referred to with the same reference numerals. The exemplary embodiments described herein relate to systems and methods for Internet Protocol (“IP”) routing. Specifically, the exemplary embodiments relate to systems and methods using lock-less multi-core IP forwarding having dedicated forwarding cores. Accordingly, exemplary embodiments may offer wire-rate on multiple gigabit links while guaranteeing packet order.

Furthermore, the exemplary embodiments describe an operating system utilizing multiple IP forwarding cores without a use of spin locks or non-deterministic atomic operators. A spin lock may be described as a mechanism in which a thread of execution waits in a locked loop and repeatedly checks for the availability of a processing resource. Once the processing resource becomes available, the loop is unlocked (e.g., released) and the thread is provided with access to the processor. As will be described in detail below, the lock-less multi-core IP forwarding techniques use an ability to send data packets between software resources using different cores without the use of spin locks or atomic operators. Each of the different IP forwarding cores may include individual per-instance transmission queues in order to achieve multiple wire-rate flows.

In software development, multi-core technology is the next transformative technology for the device software optimization (“DSO”) industry. Accordingly, software platforms may be enhanced with symmetric multiprocessing (“SMP”) capabilities within the operating system, network stack, and development tools in order to provide an efficient path for realizing the benefits of multi-core technology. An SMP system involves a multiprocessor computer architecture wherein two or more identical processors may be connected to a single shared main memory. Furthermore, the SMP architecture may also apply to multi-core processors, where each core may be treated as a separate processor. In other words, a single instance of the operating system may use multiple processors in a single system. The SMP system may maintain the same key real-time operating systems (“RTOS”) characteristics of performance, small footprint, high reliability, and determinism as a uniprocessor system configuration.

Advantages of the SMP system include true concurrent execution of tasks and interrupts during multitasking, priority-based concurrent task scheduler for managing the concurrent execution of tasks and automatic load balancing on different processors, mutual exclusion for synchronization between tasks and interrupts received simultaneously on different processors, processor affinity for assigning specific tasks or interrupts to a specific processor, etc. Applications that use an application programming interface (“API”) defined for SMP may also have compatibility with a uniprocessor system configuration. In addition, software platforms, such as VxWorks distributed by Wind River Systems, Inc. of Alameda, Calif., may provide SMP simulation capabilities for the development of SMP application without physical hardware. For instance, SMP simulators may be provided with all the standard uniprocessor VxWorks installations as an introduction to the SMP product.

It should be noted that while the exemplary embodiments are described with reference to an SMP operating system, those skilled in the art will understand that the functionality described herein may be transferred to other types of operating systems. For instance, any type of operating system that supports a multi-processor architecture or multi-instancing of a single processor, such as SMP, asymmetric multiprocessing (“AMP”), etc. It should also be noted that the terms “processor” and “CPU” are used interchangeably throughout this description and should be understood to mean any type of computing device that is capable of executing instructions, for example, general purpose processors, embedded processors, digital signal processors (“DSPs”), application specific integrated circuits (“ASICs”), etc.

Throughout this description, hardware operating environments may be described as having multiple CPUs, wherein any given task may have an affinity to one of the CPUs. However, there may be a variety of hardware platforms on which the present invention may be implemented. Specifically, the technique according to the exemplary embodiments may be applied equally to priority-based preemptive scheduling for a multi-CPU target hardware platform, wherein the hardware contains multiple identical CPU processing chips; a multi-core CPU target hardware platform, wherein a single CPU processing chip contains multiple identical processor cores; or a multi-threaded CPU target hardware platform, wherein a single CPU processing chip provides multiple virtual processing elements.

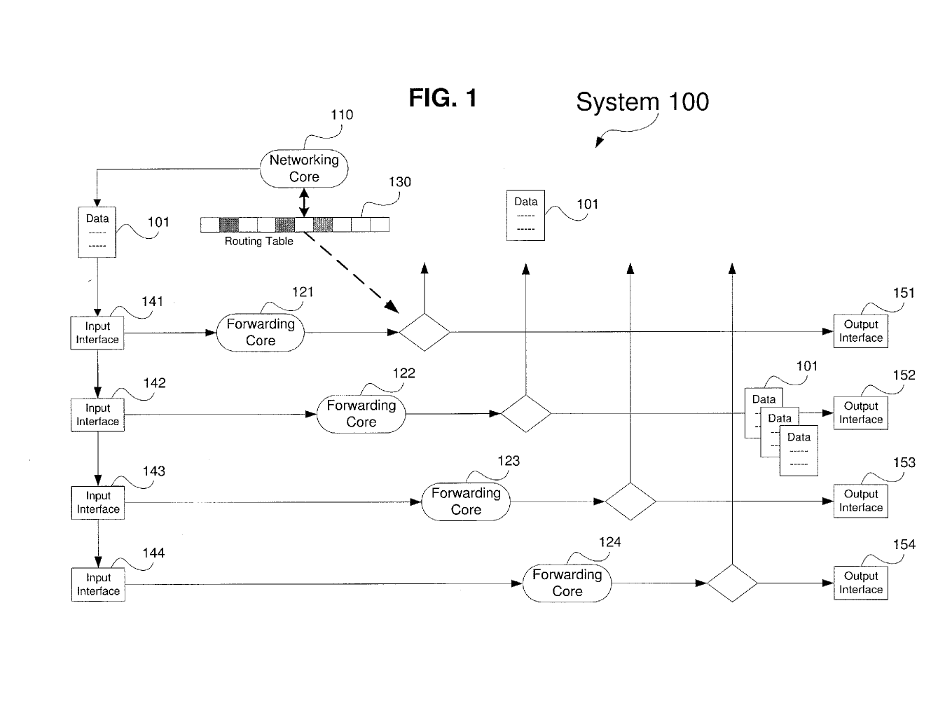

FIG. 1 shows an exemplary embodiment of a system 100 for offering wire-rate on multiple links with guaranteed packet order according to the exemplary embodiments described herein. The system 100 may include a networking core 110, a plurality of IP forwarding cores 121-124, a routing table 130, and a memory 140. Each of the IP forwarding cores 121-124 may be in communication with one of a plurality of corresponding input interfaces 141-144 (e.g., packet transmit queues), as well as one of a plurality of corresponding output interfaces 151-154 (e.g., packet receive queues). Accordingly, information (e.g., data 101) may be transmitted throughout the system 100, from the networking core 110 to one of the input interfaces 141-144 and then forwarded by one of the IP forwarding cores 121-124 to the output interfaces 151-154.

The networking core 110 may be described as the central part of a network for providing data and services throughout the system 100. In other words, the networking core 110 may be a high capacity communication facility connected to various sub-cores, such as the IP forwarding cores 121-124. Accordingly, the networking core 110 may route data to the IP forwarding cores 121-124 based on information retrieved from the routing table 130. In addition, the routing table 130 may be maintained and updated periodically by the networking core 110. The services provided by the networking core 110 to the system 100 may include, but are not limited to, data aggregation, data authentication, data routing (e.g., flow control and packet switching), inter-network gateway management, etc. It should be noted that while the embodiments described herein refer to the data transmitted throughout an IP network, the exemplary systems and methods may be implemented within networks using different technologies, such as synchronous optical networking (“SONET”), dense wavelength division multiplexing (“DWDM”), asynchronous transfer mode (“ATM”) switching, etc.

The IP forwarding cores 121-124 may be described as a component in communication with the networking core 110 providing decision-based forwarding, or routing, of data packets over the system 100. Specifically, when any one of IP forwarding cores 121-124 receives a packet (e.g., data 101), the IP forwarding core 121 may retrieve routing information from the packet in the form of a destination IP address. Accordingly, the forwarding core 121 may refer to the routing table 130 to determine the best match between the destination IP address of the packet and one of the network addresses stored in the routing table 130. Once a match is found, the packet is encapsulated and transmitted to the corresponding outgoing interface 151. The bandwidth or speed of transmission across any one of these IP forwarding cores 121-124 may be referred to as a wire-rate. It should be noted that while FIG. 1 illustrates the usage of four IP forwarding cores 121-124, one skilled in the art would understand that any number of IP forwarding cores may be implemented within the system 100.

As noted above, the exemplary system 100 may include both input queues (e.g., input interfaces 141-144) and output queues (e.g., output interfaces 151-154). In reference to the input queues, assigning each of these input interfaces 141-144 to the forwarding cores 121-124 allows for the exemplary multi-core system 100 to maintain flow packet order. Specifically, binding each of the exemplary IP forwarding cores 121-124 to its corresponding input interfaces 141-144 may yield multiple wire-rate forwarding flows. Furthermore, each of the IP forwarding cores 121-124 shares various resources within the system 100, such as the memory 140 and the routing table 130. In order to maximize system performance and resource usage, each of these IP forwarding cores 121-124 may operate as independent from one another as possible.

In reference to the output queues, assigning individual per-instance output queues to the forwarding cores 121-124 allows for lock-less packet transmission within the system 100 by avoiding the need for core synchronization. According to the exemplary systems and methods described herein, the assignment of receiving queues to the forwarding cores 121-124 may guarantee packet order during transit. Thus, the underlying resources of the system 100 offer a lock-less multi-core IP forwarding operation with dedicated forwarding cores 121-124 without any need for explicit access synchronization between these shared system resources.

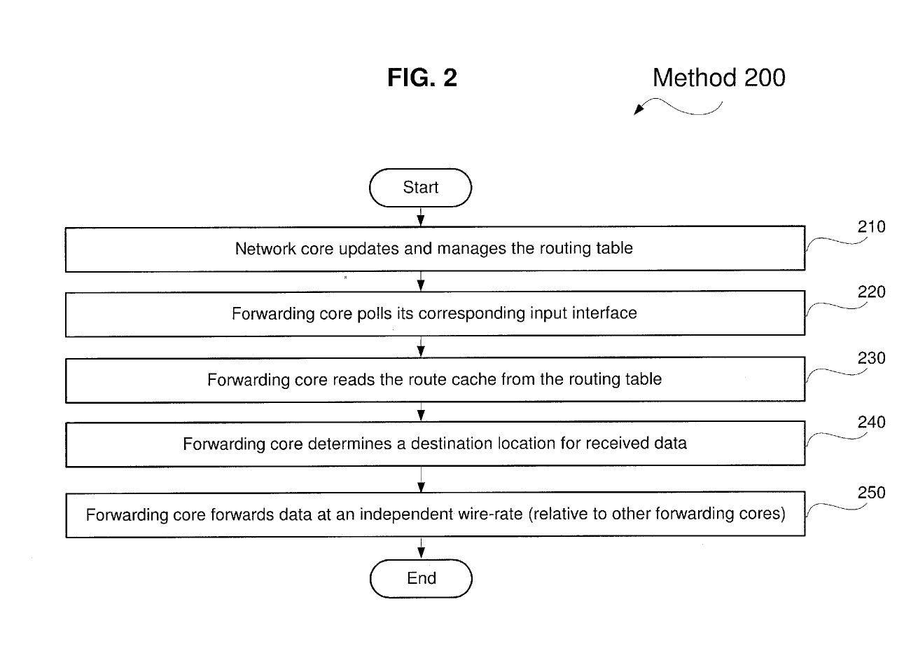

FIG. 2 shows an exemplary embodiment of a method 200 for offering wire-rate on multiple links with guaranteed packet order according to the exemplary embodiments described herein. It should be noted that the exemplary method 200 will be discussed with reference to the processor 110 and the system 100 of FIG. 1.

The method 200 may allow for a system having a plurality of processors (e.g., a multi-core architecture) to provide multiple wire-rate flows across forwarding links within the system. Therefore, using the exemplary system 100 described above, the method 200 may allow for each of the forwarding cores 121-124 within the system 100 to forward data along independent per-interface transmit queues.

In step 210, the networking core 110 may update and manage the routing table 130. Specifically, the networking core 110 may receive periodic updates, corrections, and or changes within the system 100 and adjust the routing table 130 accordingly. The building and updating of routing tables is generally known in the art.

In step 220, one or more of the IP forwarding cores 121-124 may poll its corresponding input interface 141-144. For instance, the IP forwarding core 121 may receive data 101 from the corresponding input interface 141 and poll the data 101 for destination information. The input interface 141 may be described as a transmit queue dedicated to the IP forwarding core 121. Likewise, each of the other IP forwarding cores 122-124 may also interact with a dedicated transmit queue from their respective input interfaces 142-144.

In step 230, one or more of the IP forwarding cores 121-124 may read a route cache from the route table 130. The routing table 130 may maintain a record of the routes to various network destinations. Thus, the routing table 130 may include a memory or routing cache of these various destinations.

In step 240, one or more of the IP forwarding cores 121-124 may determine a destination location for the data 101. For instance, the destination information received at the forwarding core 121 may use in a matching process in order to determine a routing path and network destination for the data 101.

In step 250, one or more of the IP forwarding cores 121-124 may forward the data 101 to the destination address at an independent wire-rate. Specifically, the independent wire-rate may be unrelated to any other wire-rates within the system 100. For instance, the IP forwarding core 121 may transmit the data 101 to the destination of the corresponding output interface 141 at a first wire-rate. This first wire-rate may be independent from wire-rates of a transmission between any of the other IP forwarding cores 122-124 to their output interfaces 142-144. Accordingly, multiple wire-rate flows may exist within the system 100 between dedicated IP forwarding core 121-124.

Those skilled in the art will understand that the above described exemplary embodiments may be implemented in any number of manners, including, as a separate software module, as a combination of hardware and software, etc. For example, the exemplary systems and methods may be implemented within a program containing lines of code stored in any type of non-transitory computer-readable storage medium that, when compiled, may be executed by a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A non-transitory computer readable storage medium including a set of instructions executable by a processor, the set of instructions operable to:
poll, by a forwarding core, data received from an input interface for routing information, wherein the forwarding core is one of a plurality of forwarding cores;
reference a routing table based on the routing information;
determine a destination for the data based on the routing table; and
transmit the data to the destination at a wire-rate, wherein the wire-rate is independent from a further wire-rate corresponding to a further forwarding core of the plurality of forwarding cores.

2. The non-transitory computer readable storage medium of claim 1, wherein the set of instructions are further operable to:
update the routing table by a network core.

3. The non-transitory computer readable storage medium of claim 1, wherein the forwarding core is a dedicated gigabit link.

4. The non-transitory computer readable storage medium of claim 1, wherein the transmitting of data to the destination is a lock-less transmission using a guaranteed packet order.

5. The non-transitory computer readable storage medium of claim 1, wherein the routing table includes a route cache of network destinations for the forwarding core.

6. The non-transitory computer readable storage medium of claim 1, wherein each of the plurality of forwarding cores includes an individual per-instance transmission queue to achieve multiple wire-rate flows to a plurality of destinations.

7. The non-transitory computer readable storage medium of claim 1, wherein the plurality of forwarding cores are components within a system utilizing one of a symmetric multiprocessing “SMP” architecture and an asymmetric multiprocessing “AMP” architecture.

8. A system, comprising:
a plurality of forwarding cores within a network; and
a routing table, wherein a first forwarding core of the plurality of forwarding cores polls data received from an input interface for routing information, references the routing table based on the routing information, determines a destination for the data based on the routing table, and transmits the data to the destination at a wire-rate, the wire-rate is independent from a further wire-rate corresponding to a further forwarding core of the plurality of forwarding cores.

9. The system of claim 8, further comprising:
a networking core updating the route table.

10. The system of claim 8, wherein the forwarding core is a dedicated gigabit link.

11. The system of claim 8, wherein the transmitting of data to the destination is a lock-less transmission using a guaranteed packet order.

12. The system of claim 8, wherein the routing table includes a route cache of network destinations for the forwarding core.

13. The system of claim 8, wherein each of the plurality of forwarding cores includes an individual per-instance transmission queue to achieve multiple wire-rate flows to a plurality of destinations.

14. The system of claim 8, wherein the plurality of forwarding cores are components within a system utilizing one of a symmetric multiprocessing “SMP” architecture and an asymmetric multiprocessing “AMP” architecture.

15. A data-forwarding system, comprising:
a polling means polling data received from an input interface for routing information;
a look-up means referencing a routing table based on the routing information;
a routing means determining a destination for the data based on the routing table; and
a transmitting means transmitting the data to the destination at a wire-rate, wherein the wire-rate is independent from a further wire-rate corresponding to a further transmitting means within the system.

16. The data-forwarding system of claim 15, further including:
an network updating means updating the routing table.

17. The data-forwarding system of claim 15, wherein the forwarding core is a dedicated gigabit link.

18. The data-forwarding system of claim 15, wherein the transmitting of data to the destination is a lock-less transmission using a guaranteed packet order.

19. The data-forwarding system of claim 15, wherein the routing table includes a route cache of network destinations for the forwarding core.

20. The data-forwarding system of claim 15, wherein each of the plurality of forwarding cores includes an individual per-instance transmission queue to achieve multiple wire-rate flows to a plurality of destinations.
